(19) United States
(12) Patent Application Publication
(10) Pub. No.: US 2004/0011894 A1
(43) Pub. Date: Jan. 22, 2004

(54) Fuel injecton valve

(76) Inventors: Guenter Dantes, Eberdingen (DE); Detlef Nowak, Untergruppenbach (DE); Matthias Waldau, Pforzheim (DE)

Correspondence Address: KENYON & KENYON, ONE BROADWAY, NEW YORK, NY, 10004, US

(21) Appl. No.: 10/297,852

(22) PCT Filed: Mar. 16, 2002
(86) PCT No.: PCT/DE02/00966

(30) Foreign Application Priority Data
Apr. 11, 2001 (DE) 101 18 164.7

(51) Int. Cl. B05B 1/30

(52) U.S. Cl. 239/585.1

(57) ABSTRACT

A fuel injector for fuel-injection systems of internal combustion engines includes a magnetic coil; a valve needle that is in operative connection with the magnetic coil and acted upon by a restoring spring in a closing direction, in order to actuate a valve-closure member which, together with a valve-seat face formed at a valve-seat member, forms a sealing seat; and a spray-orifice plate situated downstream from the valve-seat member. The spray-orifice plate has a dome-shaped curved design in a flow direction of the fuel.

### BACKGROUND INFORMATION

German Patent Application No. 198 27 219 describes a fuel injection system for an internal combustion engine which includes an injector having a disk for adjusting the fuel jet, this disk including first nozzle orifices disposed along a first circle, and including second nozzle orifices disposed along a second circle. The second circle has a larger diameter than the first circle. The circles are positioned coaxially with respect to a center axis of the adjustment disk. Each orifice axis of the second nozzle orifices forms an acute angle to a reference plane that is perpendicular to the center axis of the valve body. The angle is smaller than that which is formed by each orifice axis of the first nozzle orifices with the reference plane. Therefore, fuel atomizations, which are injected through the first nozzle orifices, can be directed away from the fuel atomizations being injected through the second nozzle orifices. As a result, the fuel atomizations injected through the first nozzle orifices do not interfere with the fuel atomizations injected through the second nozzle orifices, thereby allowing an appropriate atomization of the injected fuel.

The disadvantages of the mixture-formation method or of the fuel injector known from the aforementioned printed publication are, in particular, the lacking homogeneity of the mixture cloud and the problem of transporting the ignitable mixture to the region of the spark gap of the spark plug. In order to allow a low-emission, economical fuel combustion, complicated combustion-chamber geometries, swirl valves or turbulence mechanisms must be employed in order, on the one hand, to fill the combustion chamber with the fuel/air mixture and, on the other hand, to guide the ignitable mixture to the spark plug.

In the process, the spray mostly acts directly on the spark plug. This has the result that heavy deposits form on the spark plug and frequent thermo shocks occur, resulting in a shorter service life of the spark plug.

### SUMMARY OF THE INVENTION

The fuel injector according to the present invention has the advantage over the related art that a dome-shaped curved spray-orifice plate is mounted on the downstream end of the valve-seat member of the fuel injector in such a way that a deposit formation may be optimized by reducing the dead volume.

The spray-orifice plate may advantageously be produced in a simple manner and inserted into a recess of the fuel injector downstream from the sealing seat. A welding seam may be used, for instance, to affix the spray-orifice plate.

In particular, the stress due to thermo shock and the deposit formation on the spark plug are reduced by an optimal orifice design of the spray-discharge orifices. Sharp-edged spray-discharge orifices and their conical design prevent the fuel flow in the spray-discharge orifice from separating, thereby substantially reducing the formation of deposits.

The conical spray-discharge orifices have the advantage that the pressure drop of the fuel at the discharge opening is minimal and, thus, maximum pressure energy is available for the jet formation.

By selectively configuring the spray-discharge orifices and, thus, the injection jets in the combustion chamber, the installation position of the inlet and outlet valves and also the spark plug in the cylinder head may be advantageously considered, even though the combustion-chamber geometry is still able to be optimally utilized.

### BRIEF DESCRIPTION OF THE DRAWINGS

FIG. 1 shows a schematic section through a first exemplary embodiment of a fuel injector according to the present invention.

FIG. 2 shows a schematic section through the discharge-end section of the exemplary embodiment of the fuel injector according to the present invention represented in FIG. 1, in region II in FIG. 1.

FIG. 3 shows a schematic section through a second exemplary embodiment of the fuel-injection system according to the present invention in the same region as FIG. 2.

FIG. 4 shows a schematic section through the spray-orifice plate of the exemplary embodiment of the fuel injector according to the present invention represented in FIG. 2, in region IV in FIG. 2.

### DETAILED DESCRIPTION

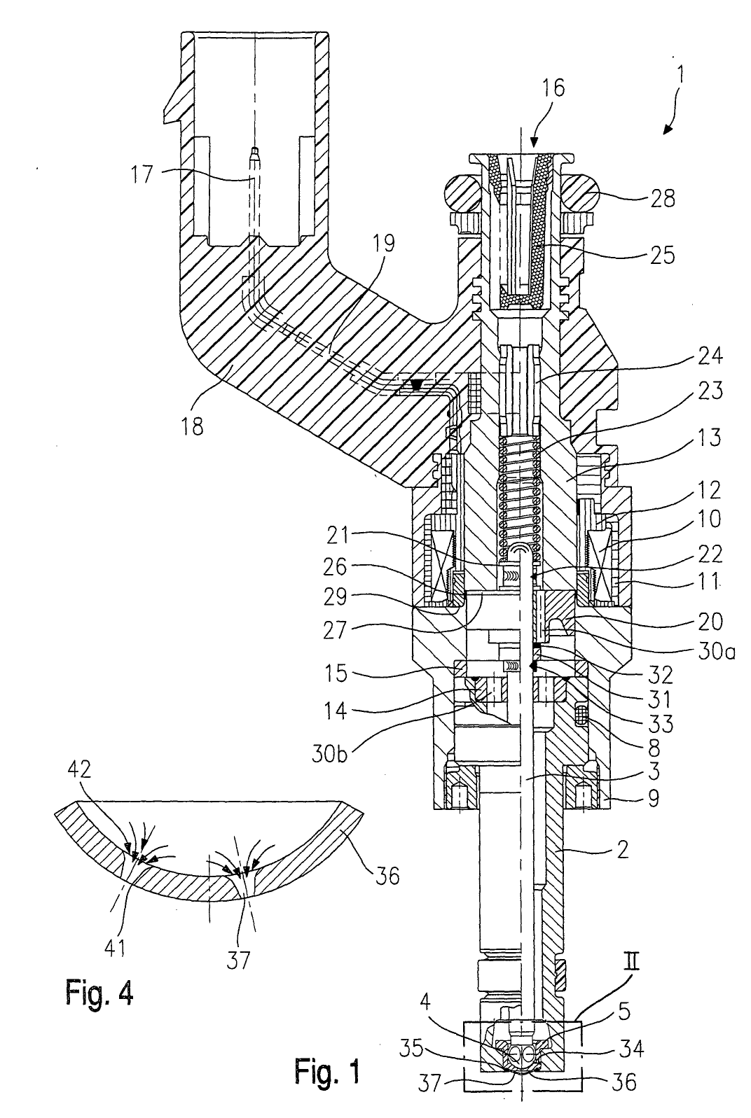

FIG. 1 shows a part-sectional view of a first exemplary embodiment of a fuel injector 1 according to the present invention. Fuel injector 1 is designed for fuel-injection systems of mixture-compressing internal combustion engines having external ignition. It is suited for the direct injection of fuel into a combustion chamber (not shown) of an internal combustion engine.

Fuel injector 1 is composed of a nozzle body 2 in which a valve needle 3 is positioned. Valve needle 3 is in operative connection with a valve-closure member 4 which cooperates with a valve-seat surface 6 disposed on a valve-seat member 5 to form a sealing seat. In the exemplary embodiment, fuel injector 1 is an inwardly-opening fuel injector 1, which is provided with a bore 7 on the downstream side of the sealing seat for conveying the fuel.

Valve-closure member 4 of fuel injector 1 designed according to the present invention has a nearly spherical shape. This enables a displacement-free, cardanic valve-needle guidance to be obtained, thereby providing for a precise functioning of fuel injector 1.

Valve-seat member 5 of fuel injector 1 has a nearly cup-shaped design and, by its form, contributes to the valve-needle guidance. Valve-seat member 5 is inserted into a discharge-side recess 34 of nozzle body 2 and connected to nozzle body 2 by a welding seam 35. Situated between nozzle body 2 and valve-seat member 5 is a spray-orifice disk curved in a dome shape, which is fixedly held between nozzle body 2 and valve-seat member 5 by a welding seam 35.

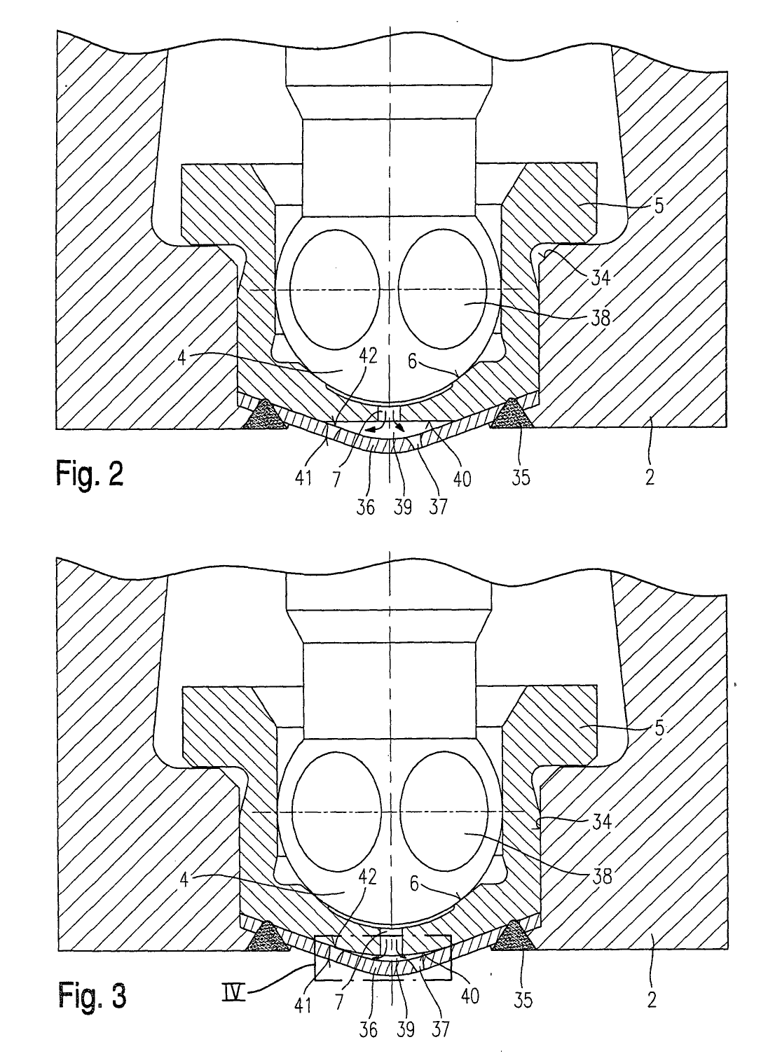

Spray-orifice disk 36 closes off fuel injector 1 on the downstream side and in doing so covers bore 7. The fuel flowing through fuel injector 1 is injected into the combustion chamber (not shown further) of the internal combustion engine via a plurality of spray-discharge orifices 37 configured in spray-orifice disk 36. A more detailed description of spray-orifice disk 36 may be inferred from the description with respect to FIGS. 2 through 4.

A seal 8 seals nozzle body 2 from an outer pole 9 of a magnetic coil 10. Magnetic coil 10 is encapsulated in a coil housing 11 and wound on a coil brace 12, which rests against an inner pole 13 at magnetic coil 10. Inner pole 13 and outer pole 9 are separated from one another by a gap 26 and are braced on a connecting member 29. Magnetic coil 10 is energized via an electric line 19 by an electric current, which can be supplied via an electrical plug contact 17. A plastic coating 18, which may be extruded onto internal pole 13, encloses plug contact 17.

Valve needle 3 is guided in a valve-needle guide 14, which is disk-shaped. A paired adjustment disk 15 is used to adjust the (valve) lift. An armature 20 is on the other side of adjustment disk 15. It is connected by force-locking to valve needle 3 via a first flange 21, and valve needle 3 is connected to first flange 21 by a welded seem 22. Braced against first flange 21 is a return spring 23 which, in the present design of fuel injector 1, is prestressed by a sleeve 24.

On the discharge-side of armature 20 is a second flange 31 which is used as lower armature stop. It is connected to valve needle 3 via a welding seam 33 in a force-locking fit. An elastic intermediate ring 32 is positioned between armature 20 and second flange 31 to damp armature bounce during closing of fuel injector 1.

Fuel channels 30a through 30c run through valve needle guide 14, armature 20 and valve seat member 5, which conduct the fuel, supplied via central fuel supply 16 and filtered by a filter element 25, to spray-discharge opening 7. A seal 28 seals fuel injector 1 from a distributor line (not shown further).

In the rest state of fuel injector 1, return spring 23 acts upon first flange 21 at valve needle 3, contrary to its lift direction, in such a way that valve-closure member 4 is retained in sealing contact against valve seat 6. Armature 20 rests on intermediate ring 32, which is supported on second flange 31. When magnetic coil 10 is energized, it builds up a magnetic field which moves armature 20 in the lift direction against the spring tension of return spring 23. Armature 20 carries along first flange 21, which is welded to valve needle 3, and thus valve needle 3, in the lift direction as well. Valve closure member 4, being operatively connected to valve needle 3, lifts off from valve seat surface 6, and the fuel guided via fuel channels 30a through 30c to spray-discharge orifice 7 is sprayed off.

When the coil current is turned off, once the magnetic field has sufficiently decayed, armature 20 falls away from internal pole 13, due to the pressing force of restoring spring 23 on first flange 21, whereupon valve needle 3 moves in a direction counter to the lift. As a result, valve closure member 4 comes to rest on valve-seat surface 6, and fuel injector 1 is closed. Armature 20 comes to rest against the armature stop formed by second flange 31.

FIG. 2, in a part-sectional view, shows the cut-away portion, designated II in FIG. 1, from the first exemplary embodiment of a fuel injector 1 according to the present invention represented in FIG. 1.

As already mentioned in the description of FIG. 1, a spray-orifice plate is situated at a downstream end of fuel injector 1, which seals fuel injector 1 from the combustion chamber. Spray-orifice plate 36 is fixed to valve-seat member 5 by a welding seam 35, which connects valve-seat member 5 to nozzle body 2. Bore 7 is also covered by spray-orifice plate 36. The injection of fuel into the combustion chamber of the internal combustion chamber is carried out by spray-discharge orifices 37, which are formed in spray-orifice plate 36 and are offset with respect to bore 7, which is centrally disposed in valve-seat member 5. As a result, the fuel flow is rerouted, so that there is less of a necessity for inclination of spray-discharge orifices 37. This, in turn, facilitates their production and increases the precision obtained in manufacturing.

Spray-orifice plate 36 has a dome-shaped curved design in the present exemplary embodiment and is adapted to valve-seat member 5. The advantage of the calotte form of spray-orifice plate 36, on the one hand, is the easy producibility and, on the other hand, the flexibility with respect to fuel injectors 1, which may be provided with the dome-shaped spray-orifice plate 36.

When the fuel has passed through valve-closure member 4, which has several chamfers 38, and bore 7, it enters a volume 39, which is formed between an end face 40 of valve-seat member 5 and spray-orifice plate 36. Due to the fuel pressure, the fuel, changing direction, is injected into the combustion chamber of the internal combustion engine through spray-discharge orifices 37 formed in spray-orifice plate 36.

Spray-discharge orifices 37 have a conical shape and, in particular, have sharp discharge edges 41 and a funnel-shaped inflow region 42. This orifice design has the particular advantage that the fuel flow inside spray-discharge orifices 37 is not cut off, so that the outlet orifices of spray-discharge orifices 37, which taper toward the combustion chamber, are completely filled with fuel across their cross-section. This makes it possible to prevent the formation of deposits, since there is no recirculation of the fuel in spray-discharge orifice 37.

Spray-orifice plate 36 is able to be flexibly adapted for any jet-opening angle and tilting angle of the sealing seat and also for any static flow-rate values through fuel injector 1.

FIG. 3 shows a second exemplary embodiment of a fuel injector 1 designed according to the present invention, in the same view as FIG. 2. Identical components are denoted by equivalent reference numerals.

In contrast to FIG. 2, in the present exemplary embodiment, valve-seat member 5 and spray-orifice plate 36 are adapted to each other in their form, i.e., volume 39 formed between valve-seat member 5 and spray-orifice plate 36 is smaller than in the first exemplary embodiment shown in FIG. 2.

The remaining components of fuel injector 1 may be identical in design to those of fuel injector 1 shown in FIGS. 1 and 2.

Reducing volume 39 permits the fuel flow to be homogenized. This does not cease during the dead times of fuel injector 1. The deposit formation is thereby reduced as well.

The flow diversion is also intensified by the reduction in volume 39, thereby facilitating a further decrease in the inclination of spray-discharge orifices 37 and a further enhancement of the manufacturing precision of spray-discharge orifices 37.

FIG. 4 shows a part-sectional, highly schematic view of a cut-away portion of spray-orifice plate 36 of a fuel injector 1 designed according to the present invention, in region IV in Figure III.

In FIG. 4, the conical shape of spray-discharge orifices 37 having the funnel-shaped inflow region 42 and sharp edges 41 is clearly visible. The most narrow cross-section of spray-discharge orifices 37 is formed on the downstream side and works to suppress recirculation in spray-discharge orifice 37, since the fuel stream is not cut off, and the discharge cross-section is thereby continuously filled with fuel.

Spray-discharge orifices 37 in spray-orifice plate 36 may be produced by single-layer micro-electroplating, stamping, etching or laser drilling, while spray-orifice plate 36 still has a planar form. Following the production of spray-discharge orifices 37, spray-orifice plate 36 is given a dome-shaped form, for instance, by stamping.

The present invention is not limited to the exemplary embodiments shown and may also be used in inwardly-opening fuel injectors of any desired design.

What is claimed is:

1. A fuel injector (1) for fuel-injection systems of internal combustion engines, comprising an energizable actuator (10), a valve needle (3) that is in operative connection with the actuator (10) and acted upon in a closing direction by a restoring spring (23) to actuate a valve-closure member (4), which, together with a valve-seat surface (6) formed at a valve-seat member (5), forms a sealing seat; and comprising a spray-orifice plate (36) situated on the downstream side of valve-seat member (5), wherein the spray-orifice plate (36) has a dome-shaped curved design in a flow direction of the fuel.

2. The fuel injector as recited in claim 1,
wherein the spray-orifice place (36) is situated in a recess (34) of a nozzle body (2) of the fuel injector (1).

3. The fuel injector as recited in claim 2,
wherein the spray-orifice plate (36) is fixed to the nozzle body (2) of the fuel injector (1) by a welding seam (35).

4. The fuel injector as recited in claim 3,
wherein the welding seam (35) extends into the valve-seat member (5).

5. The fuel injector as recited in one of the claims 1 through 4,
wherein a bore (7), centrally positioned in the valve-seat member (5), is covered by the spray-orifice plate (36).

6. The fuel injector as recited in one of claims 1 through 5,
wherein a plurality of spray-discharge orifices (37) is formed in the spray-orifice plate (36).

7. The fuel injector as recited in claim 6,
wherein none of the spray-discharge orifices (37) is positioned in a longitudinal axis of the bore (7).

8. The fuel injector as recited in claim 6 or 7,
wherein the spray-discharge orifices (37) have a conical design.

9. The fuel injector as recited in claim 8,
wherein the spray-discharge orifices (37) taper in the flow direction of the fuel.

10. The fuel injector as recited in claim 9,
wherein the spray-discharge orifices (37) have a funnel-shaped inflow region (42) on the inflow side.

11. The fuel injector as recited in claim 10,
wherein the spray-discharge orifices (37) have sharp edges (41) on the discharge side.

12. The fuel injector as recited in one of claims 1 through 11,
wherein a volume (39) is formed between the spray-orifice plate (36) and an end face (40) of the valve-seat member (5).
a restoring spring acting upon the valve needle in a closing direction to actuate the valve-closure member; and
a spray-orifice plate situated on the downstream side of the valve-seat member, the spray-orifice plate having a dome-shaped curved design in a flow direction of the fuel.

14. The fuel injector according to claim 13, further comprising a nozzle body, the spray-orifice plate being situated in a recess of the nozzle body.

15. The fuel injector according to claim 14, wherein the spray-orifice plate is fixed to the nozzle body by a welding seam.

16. The fuel injector according to claim 15, wherein the welding seam extends into the valve-seat member.

17. The fuel injector according to claim 13, further comprising a bore centrally situated in the valve-seat member, the bore being covered by the spray-orifice plate.

18. The fuel injector according to claim 17, wherein the spray-orifice plate has a plurality of spray-discharge orifices.

19. The fuel injector according to claim 18, wherein none of the spray-discharge orifices is situated in a longitudinal axis of the bore.

20. The fuel injector according to claim 18, wherein the orifices have a conical design.

21. The fuel injector according to claim 20, wherein the orifices taper in a flow direction of the fuel.

22. The fuel injector according to claim 21, wherein the orifices have a funnel-shaped inflow region on an inflow side.
